(19) United States
(12) Patent Application Publication
(10) Pub. No.: US 2016/0187683 A1
(43) Pub. Date: Jun. 30, 2016

(54) LIGHT MODULATION DEVICE

(71) Applicant: SAMSUNG DISPLAY CO., LTD., YONGIN-CITY (KR)

(72) Inventors: HYUN SEUNG SEO, ANYANG-SI (KR); SOO HEE OH, HWASEONG-SI (KR)

(21) Appl. No.: 14/718,235

(22) Filed: May 21, 2015

(30) Foreign Application Priority Data
Dec. 29, 2014 (KR) 10-2014-0192264

(51) Int. Cl. G02F 1/1337; G02F 1/1343

(52) U.S. Cl. CPC G02F 1/1337; G02F 1/134309

(57) ABSTRACT

An optical modulation device includes: a first plate and a second plate that face each other and that include a plurality of unit regions; and a liquid crystal layer positioned between the first plate and the second plate that includes a plurality of liquid crystal molecules, wherein the first plate includes a plurality of lower electrodes, the second plate includes at least one upper electrode, a pretilt angle P1 of a long axis of the liquid crystal molecules with respect to a surface of the first plate or the second plate when no electric field is generated in the liquid crystal layer and an abnormal inclination angle P2 of the liquid crystal molecules with respect to a surface of the first plate or the second plate in an abnormal region of the liquid crystal molecules satisfy (90-P1)/(90-P2)=K, where K is larger than about 0.2.

### CROSS-REFERENCE TO RELATED APPLICATION

This application claims priority under 35 U.S.C.§119 from Korean Patent Application No. 10-2014-0192264 filed in the Korean Intellectual Property Office on Dec. 29, 2014, and all the benefits accruing therefrom, the contents of which are herein incorporated by reference in their entirety.

### BACKGROUND

(a) Technical Field

Embodiments of the present disclosure are directed to an optical modulation device. More particularly, embodiments of the present disclosure are directed to an optical modulation device that includes a liquid crystal.

(b) Discussion of the Related Art

In recent years, the development of optical display devices that can display a three-dimensional image has attracted attention. To display a three-dimensional image, an optical modulation device divides and output images at different points in time so that a viewer can perceive an image as a stereoscopic image. An optical modulation device that may be used as a stereoscopic image display device includes a lens and a prism to change a light path of the image to output it at a desired time.

Light diffraction due to phase modulation may be used to change the direction of incident light.

When polarized light passes through a light modulator, such as a phase retarder, the polarization state changes. For example, when circularly polarized light is incident to a half-wave plate, the direction of rotation of the circularly polarized light changes. For example, when left circularly polarized light passes through the half-wave plate, it changes into right circularly polarized light. At this time, the phase of the circularly polarized light that is emitted changes along the angle of the optical axis of the half-wave plate, that is, along the slow axis. In detail, when the optical axis of the half-wave plate rotates by φ in-plane, the phase of the output light changes by 2φ. Accordingly, when the optical axis of the half-wave plate changes by 180 degrees (πradian) in the x-axis direction, the emitted light has a phase modulation or phase change of 360 degrees (2π radian) in the x-axis direction. As described above, when an optical modulation device causes a phase change of between 0 to 2π, a diffraction lattice or prism that can change the direction of light may be realized. A liquid crystal may be used to control the optical axis of an optical modulation device, such as the half-wave plate. In an optical modulation device implemented as the phase retarder using a liquid crystal, an electric field is applied to the liquid crystal layer to rotate the long axis of the liquid crystal molecules, thereby generating phase modulations that may differ by position. The phase of the light emitted from the optical modulation device may be determined from the direction of the long axis of the liquid crystals, that is, an azimuthal angle.

### SUMMARY

Exemplary embodiments of the present disclosure may realize a prism, a diffraction lattice, a lens, etc., by generating a continuous spatial phase modulation using an optical modulation device using a liquid crystal in which liquid crystal molecules have their major axes continuously changed in spatial direction. To obtain a phase profile in which the emitted light changes from 0 to 2π, the optical axes of the half-wave plate change from 0 to π. For this, the substrate adjacent to the liquid crystal layer should be aligned in different directions according to positions, and it may be challenging to uniformly align the substrate such that a display failure may occur.

Accordingly, embodiments of the present disclosure may easily control the rotation angle on the in-plane of liquid crystal molecules in an optical modulation device that includes liquid crystals to modulate the light phase.

Also, embodiments of the present disclosure may provide an optical modulation device that can prevent liquid crystal molecules of the optical modulation device from being arranged in an abnormal direction by a foreign particle that may render normal phase modulation impossible by propagation of the abnormal arrangement, and an optical device including the same.

An optical modulation device according to an exemplary embodiment of the present disclosure includes: a first plate and a second plate that face each other and that include a plurality of unit regions; and a liquid crystal layer positioned between the first plate and the second plate and that includes a plurality of liquid crystal molecules, wherein the first plate includes a plurality of lower electrodes, the second plate includes at least one upper electrode, a pretilt angle P1 of a long axis of the liquid crystal molecules with respect to a surface of the first plate or the second plate when no electric field is generated in the liquid crystal layer and an abnormal inclination angle P2 of the liquid crystal molecules with respect to a surface of the first plate or the second plate in an abnormal region of the liquid crystal layer satisfy (90-P1)/(90-P2)=K, where K is larger than about 0.2.

When no electric field is generated in the liquid crystal layer, the pretilt direction of the liquid crystal molecules near the first plate and the pretilt direction of the liquid crystal molecules near the second plate may be opposite to each other.

When an electric field is generated in the liquid crystal layer by the plurality of lower electrodes and the at least one upper electrode, an electric field intensity in a region of the liquid crystal layer near a first lower electrode of the plurality of lower electrodes may be greater than electric field intensity in a region of the liquid crystal layer near the upper electrode.

The electric field intensity in a region of the liquid crystal layer near a second lower electrode of the plurality of lower electrodes that is adjacent to the first lower electrode may be less than an electric field intensity in a region of the liquid crystal layer near the upper plate.

A voltage applied to the first lower electrode may be larger than a voltage applied to the second lower electrode.

The abnormal region may be generated by a foreign particle that may be present in the liquid crystal layer.

The abnormal region may gradually disappear after the electric field is generated in the liquid crystal layer.

The first plate may include a first aligner and the second plate may include a second aligner, an alignment direction of the first aligner and an alignment direction of the second aligner may be substantially parallel to each other, and the pretilt direction of the liquid crystal molecules near the first plate may be determined by the alignment direction of the first aligner and the pretilt direction of the liquid crystal molecules near the second plate may be determined by the alignment direction of the second aligner.

An optical modulation device according to another exemplary embodiment of the present disclosure includes a first plate that includes a plurality of lower electrodes spaced apart from each other, wherein each lower electrode is associated with one of a plurality of unit regions, a second plate that faces the first plate and that includes at least one upper electrode, and a liquid crystal layer positioned between the first plate and the second plate and that includes a plurality of liquid crystal molecules, wherein when an electric field is generated in the liquid crystal layer by the plurality of lower electrodes and the at least one upper electrode, an electric field intensity in a first unit region of the liquid crystal layer near a first lower electrode of the plurality of lower electrodes is greater than the electric field intensity in the first unit region near the upper electrode, and the electric field intensity in a second unit region the liquid crystal layer near a second lower electrode of the plurality of lower electrodes that is adjacent to the first lower electrode is less than the electric field intensity in the second unit region near the upper electrode.

A pretilt angle P1 of a long axis of the liquid crystal molecules with respect to a surface of the first plate or the second plate when no electric field is generated in the liquid crystal layer and an abnormal inclination angle P2 of the liquid crystal molecules with respect to a surface of the first plate or the second plate in an abnormal region of the liquid crystal layer may satisfy (90-P1)/(90-P2)=K, wherein K is larger than about 0.2.

A voltage applied to the first lower electrode may greater than a voltage applied to the second lower electrode.

The abnormal region may be generated by a foreign particle that is present in the liquid crystal layer.

The abnormal region may gradually disappear after the electric field is generated in the liquid crystal layer.

The first plate may include a first aligner and the second plate may include a second aligner, an alignment direction of the first aligner and an alignment direction of the second aligner may be substantially parallel to each other, and the pretilt direction of the liquid crystal molecules near the first plate may be determined by the alignment direction of the first aligner and the pretilt direction of the liquid crystal molecules near the second plate may be determined by the alignment direction of the second aligner.

When no electric field is generated in the liquid crystal layer, the pretilt direction of the liquid crystal molecules near the first plate and the pretilt direction of the liquid crystal molecules near the second plate may be opposite to each other.

A method of driving an optical modulation device according to another exemplary embodiment of the present disclosure, wherein optical modulation device includes a first plate that include a plurality of first and second lower electrodes that alternate with each other, a second plate that faces the first plate and that has at least one upper electrode, and a liquid crystal layer positioned between the first plate and the second plate and that includes a plurality of liquid crystal molecules, includes the steps of applying a first voltage to the plurality of first and second lower electrodes and the at least one upper electrode to generate an electric field in the liquid crystal layer, wherein the voltage applied to a first lower electrode differs from a voltage applied to a second lower electrode, applying second voltages of equal magnitudes and opposite polarities to each of the first and second lower electrodes, respectively, and applying a third voltage to the plurality of first and second lower electrodes, wherein relative magnitudes of the voltages applied to the first lower electrodes and the second lower electrodes are reversed from those of the first voltage.

A pretilt angle P1 of a long axis of the liquid crystal molecules with respect to a surface of the first plate or the second plate when no electric field is generated in the liquid crystal layer and an abnormal inclination angle P2 of the liquid crystal molecules with respect to a surface of the first plate or the second plate in an abnormal region of the liquid crystal layer may satisfy (90-P1)/(90-P2)=K, wherein K is larger than about 0.2.

The abnormal region may be generated by a foreign particle present in the liquid crystal layer, wherein the abnormal region gradually disappears after the electric field is generated in the liquid crystal layer.

When no electric field is generated in the liquid crystal layer, the pretilt direction of the liquid crystal molecules near the first plate and the pretilt direction of the liquid crystal molecules near the second plate may be opposite to each other.

According to an exemplary embodiment of the present disclosure, in the optical modulation device including a liquid crystal layer, the light phase may be modulated by controlling the in-plane rotation angle of the liquid crystal molecules.

In addition, liquid crystal molecules of the optical modulation device may be prevented from aligning in an abnormal direction by a foreign particle and an abnormal arrangement may be prevented from spreading.

### BRIEF DESCRIPTION OF THE DRAWINGS

FIG. 1 is a perspective view of an optical modulation device according to an exemplary embodiment of the present disclosure.

FIG. 2 is a top plan view of an alignment direction in a first plate and a second plate of an optical modulation device according to an exemplary embodiment of the present disclosure.

FIG. 3 illustrates a process of assembling the first plate and the second plate shown in FIG. 1.

FIG. 4 is a perspective view of an arrangement of liquid crystal molecules when no voltage difference is applied to a first plate and a second plate of an optical modulation device according to an exemplary embodiment of the present disclosure.

FIG. 5 is a cross-sectional view of the optical modulation device shown in FIG. 4 taken along planes I, II, and III.

FIG. 6 is a perspective view of an arrangement of liquid crystal molecules when a voltage difference is applied to a first plate and a second plate of an optical modulation device according to an exemplary embodiment of the present disclosure,

FIG. 7 is a cross-sectional view of the optical modulation device shown in FIG. 6 taken along planes I, II, and III.

FIG. 8 is a perspective view of an optical modulation device according to an exemplary embodiment of the present disclosure.

FIG. 9 shows two a cross-sectional views of an arrangement of liquid crystal molecules before applying a voltage difference to a first plate and a second plate of an optical modulation device according to an exemplary embodiment of the present disclosure, taken along planes IV and V of FIG. 8.

FIG. 10 is a cross-sectional view of an arrangement of liquid crystal molecules directly after a driving signal to an optical modulation device according to an exemplary embodiment of the present disclosure, taken along a plane IV of FIG. 8.

FIG. 11 is a cross-sectional view of an arrangement of liquid crystal molecules before stabilizing after a driving signal was applied to an optical modulation device according to an exemplary embodiment of the present disclosure, taken along a plane IV of FIG. 8.

FIG. 12 is a cross-sectional view of an arrangement of liquid crystal molecules that are stable after a driving signal was applied to an optical modulation device according to an exemplary embodiment of the present disclosure, taken along planes IV and V of FIG. 8.

FIG. 13 is a cross-sectional view of an arrangement of liquid crystal molecules that are stable after a driving signal was applied to an optical modulation device according to an exemplary embodiment of the present disclosure taken along a plane V of FIG. 8 and a graph showing a phase change corresponding thereto.

FIG. 14 is a cross-sectional view of an arrangement of liquid crystal molecules before applying a voltage difference to a first plate and a second plate of an optical modulation device according to an exemplary embodiment of the present disclosure and after a driving signal is applied in three steps, taken along a plane IV of FIG. 8,

FIG. 15 is a cross-sectional view of an arrangement of liquid crystal molecules that are stable after sequentially applying a driving signal in three steps to an optical modulation device according to an exemplary embodiment of the present disclosure, taken along a plane V of FIG. 8.

FIG. 16 illustrates a phase change as a function of position of a lens realized using an optical modulation device according to an exemplary embodiment of the present disclosure.

FIG. 17 is a schematic cross-sectional view of the pretilt direction of liquid crystal molecules of an optical modulation device according to an exemplary embodiment of the present disclosure and an inclination direction of a scattered arrangement of liquid crystal molecules.

FIG. 18 is a top plan view of a liquid crystal arrangement before a driving signal is applied to an optical modulation device according to an exemplary embodiment of the present disclosure.

FIG. 19 is a top plan view of a liquid crystal arrangement after a driving signal was applied to an optical modulation device according to an exemplary embodiment of the present disclosure.

FIG. 20 is a plane view of a region where an arrangement of liquid crystal molecules is scattered by a foreign particle after a driving signal was applied to an optical modulation device according to an exemplary embodiment of the present disclosure that shows how a state has evolved from a state of an optical modulation device shown in FIG. 19.

FIG. 21 is a plane view of a region where an arrangement of liquid crystal molecules is scattered by a foreign particle after a driving signal was applied to an optical modulation device according to an exemplary embodiment of the present disclosure that shows how a state has evolved from a state of an optical modulation device shown in FIG. 20.

FIG. 22 is a graph of a relationship of a pretilt angle P1 of liquid crystal molecules of an optical modulation device according to an exemplary embodiment of the present disclosure to an abnormal inclination angle P2 of liquid crystal molecules whose arrangement is scattered by a foreign particle.

FIG. 23 is a top plan view of a liquid crystal arrangement before applying a driving signal to an optical modulation device according to an exemplary embodiment of the present disclosure.

FIG. 24 is a top plan view of a liquid crystal arrangement after applying a driving signal to an optical modulation device according to an exemplary embodiment of the present disclosure.

FIG. 25 is a plane view of a region where an arrangement of liquid crystal molecules is scattered by a foreign particle after a driving signal was applied to an optical modulation device according to an exemplary embodiment of the present disclosure that shows how a state has evolved from a state of an optical modulation device shown in FIG. 24.

FIG. 26 is a plane view of a region where a liquid crystal arrangement is scattered by a foreign particle after a driving signal was applied to an optical modulation device according to an exemplary embodiment of the present disclosure that shows how a state has evolved from a state of an optical modulation device shown in FIG. 25.

### DETAILED DESCRIPTION OF EXEMPLARY EMBODIMENTS

Exemplary embodiments of the present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present.

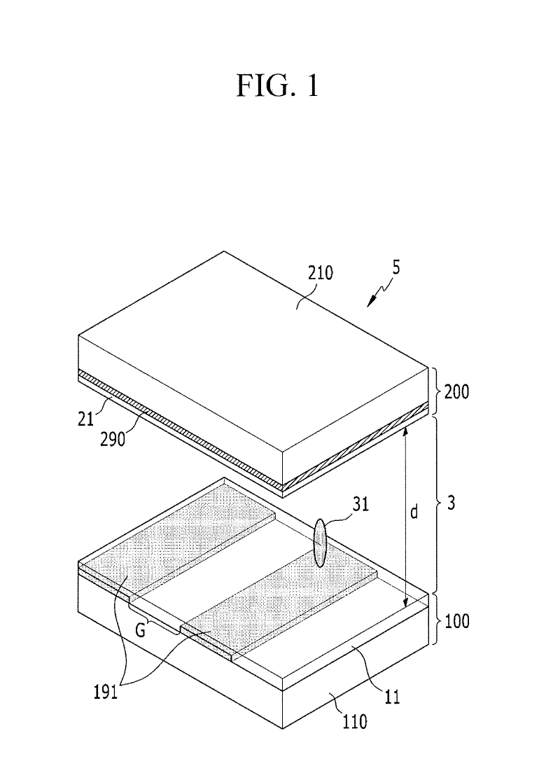

An optical modulation device according to an exemplary embodiment of the present disclosure will now be described with reference to FIG. 1 to FIG. 3.

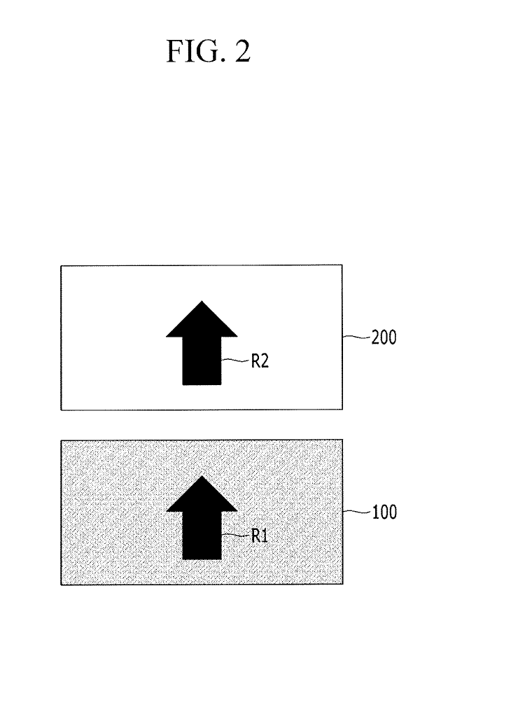

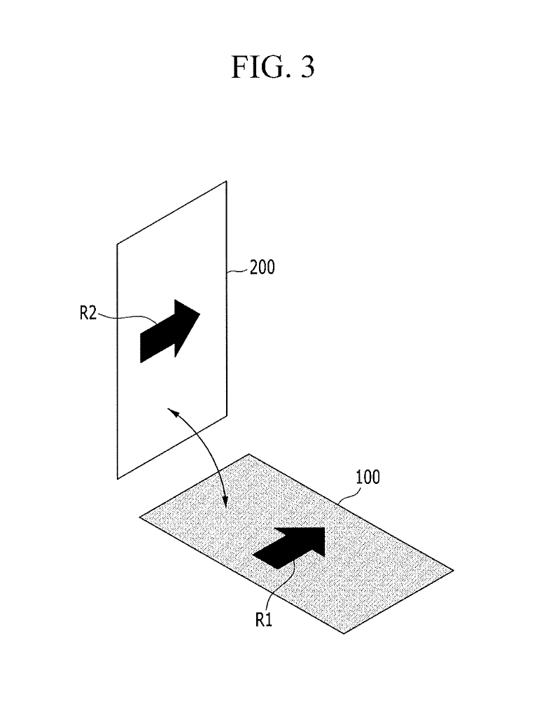

FIG. 1 is a perspective view of an optical modulation device according to an exemplary embodiment of the present disclosure, FIG. 2 is a top plan view of an alignment direction in a first plate and a second plate of an optical modulation device according to an exemplary embodiment of the present disclosure, and FIG. 3 illustrates a process of assembling the first plate and the second plate shown in FIG. 1.

Referring to FIG. 1, an optical modulation device 5 according to an exemplary embodiment of the present disclosure includes a first plate 100 and a second plate 200 facing each other, and a liquid crystal layer 3 interposed therebetween.

The first plate 100 may include a first substrate 110 that may be made of glass, plastic, etc. The first substrate 110 may be substantially rigid or flexible, flat, or at least a portion thereof may be curved.

A plurality of lower electrodes 191 may be formed on the first substrate 110. The lower electrodes 191 may include a conductive material, and may include a transparent conductive material such as ITO, IZO, or a metal. The lower electrodes 191 may be applied with a voltage from a voltage application unit, and different or adjacent lower electrodes 191 may be applied with different voltages.

A plurality of lower electrodes 191 may be arranged in a predetermined direction, for example, an x-axis direction, and each lower electrode 191 may extend in a direction perpendicular to the arrangement direction, for example, a y-axis direction.

A width of a space G between adjacent lower electrodes 191 may be adjusted depending on design conditions of the optical modulation device. A ratio of a width of the lower electrode 191 and a width of the space G adjacent thereto may be about N:1, wherein N is a real number greater than or equal to 1.

The second plate 200 may include a second substrate 210 made of glass or plastic. The second substrate 210 may be rigid or flexible, flat, or at least a portion may be curved.

An upper electrode 290 is positioned on the second substrate 210. The upper electrode 290 may include a conductive material, and may include a transparent conductive material such as ITO, IZO, or a metal. The upper electrode 290 may be applied with a voltage from the voltage application unit. The upper electrode 290 may be a singular body disposed on the second substrate 210, or may be patterned to include a plurality of separate portions.

The liquid crystal layer 3 includes a plurality of liquid crystal molecules 31. The liquid crystal molecules 31 have negative dielectric anisotropy so that they align in a transverse direction with respect to a direction of an electric field generated in the liquid crystal layer 3. The liquid crystal molecules 31 align substantially vertically with respect to the second plate 200 and the first plate 100 in the absence of an electric field in the liquid crystal layer 3, and may be pre-tilted in a predetermined direction. The liquid crystal molecules 31 may be nematic liquid crystal molecules.

A height d of a cell gap of the liquid crystal layer 3 may substantially satisfy Equation 1 for light of a predetermined wavelength (λ). Accordingly, the optical modulation device 5 according to an exemplary embodiment of the present disclosure may function as an approximate half-wave plate, and may be used as a diffraction lattice or a lens.

$$\frac{λ}{2} \times 1.3 \geq Δ nd \geq \frac{λ}{2} . \qquad Equation 1$$

In Equation 1, Δnd is a phase value of the light passing through the liquid crystal layer 3.

A first aligner 11 is positioned on an inner surface of the first plate 100 and a second aligner 21 is positioned on the inner surface of the second plate 200. The first aligner 11 and the second aligner 21 may be vertical alignment layers and may have an alignment direction produced by various methods, such rubbing or photoalignment, to determine a pretilt direction of the liquid crystal molecules 31 near the first plate 100 and the second plate 200. In the case of a rubbing process, the vertical alignment layer may be an organic vertical alignment layer. In the case of a photoalignment process, an alignment material that includes a photosensitive polymer material is coated on the inner surfaces of the first plate 100 and second plate 200 that is irradiated with light, such as ultraviolet light, to form a photopolymerized material.

Referring to FIG. 2, the alignment directions R1 and R2 of two aligners 11 and 21 positioned on the inner surfaces of the first plate 100 and the second plate 200 may be substantially parallel. Also, the alignment directions R1 and R2 of the aligners 11 and 21 are constant over the aligners 11 and 21.

If the first plate 100 and the second plate 200 are misaligned, a difference between the azimuth angle of the first aligner 11 and the azimuth angle of the second aligner 21 may be about 5 degrees, but is not limited thereto. Referring to FIG. 3, the first plate 100 and the second plate 200, including the aligners 11 and 21, are aligned with each other and assembled to form the optical modulation device 5 according to an exemplary embodiment of the present disclosure.

Alternatively, the vertical positions of the first plate 100 and the second plate 200 may be changed. As described above, according to an exemplary embodiment of the present disclosure, the aligners 11 and 21 formed on the first plate 100 and the second plate 200 are parallel to each other, and the alignment directions of the aligners 11 and 21 are constant over the aligners 11 and 21, which simplifies the alignment process of the optical modulation device, thereby simplifying the fabrication of the optical modulation device 5. Accordingly, a failure of an optical modulation device or an optical device including the same due to misalignment may be prevented.

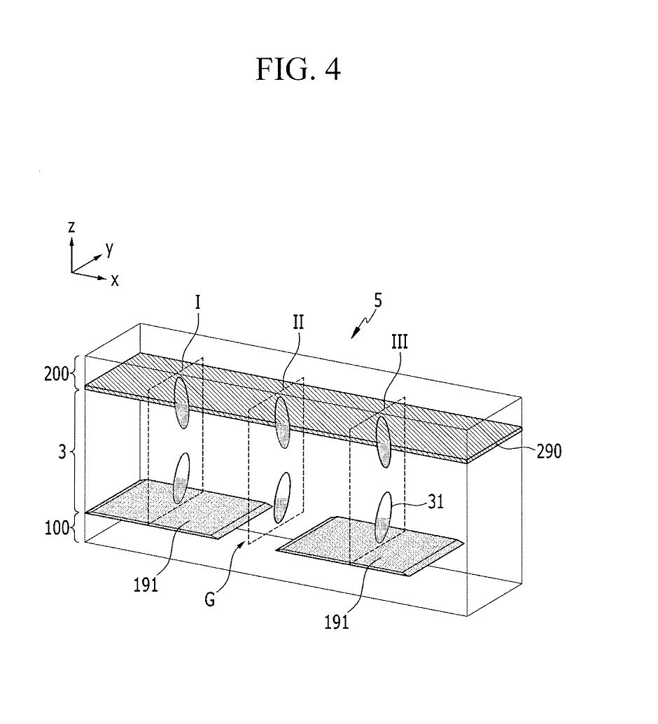

Next, an operation of an optical modulation device according to an exemplary embodiment of the present disclosure will be described with reference to FIG. 4 to FIG. 7 along with the above-described drawings.

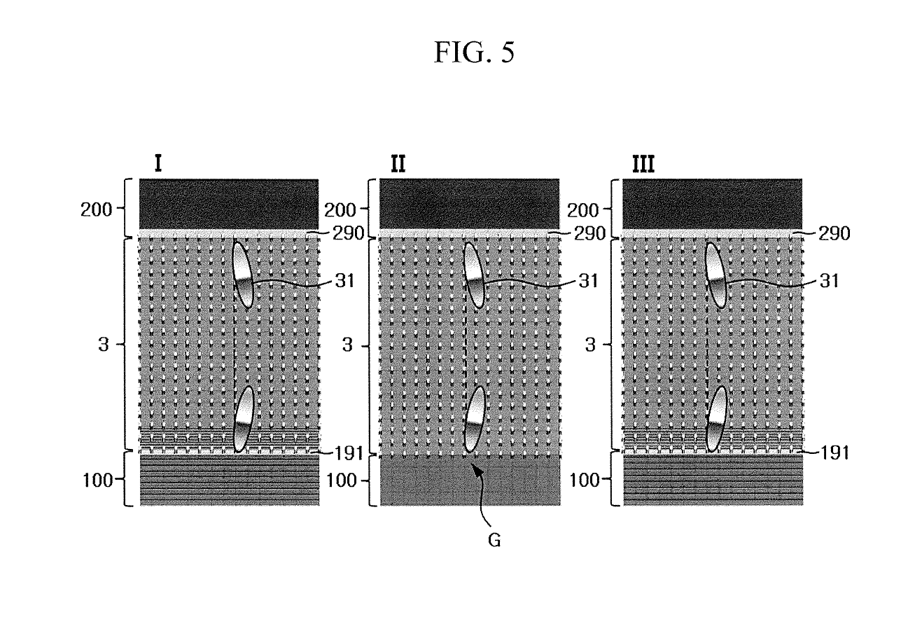

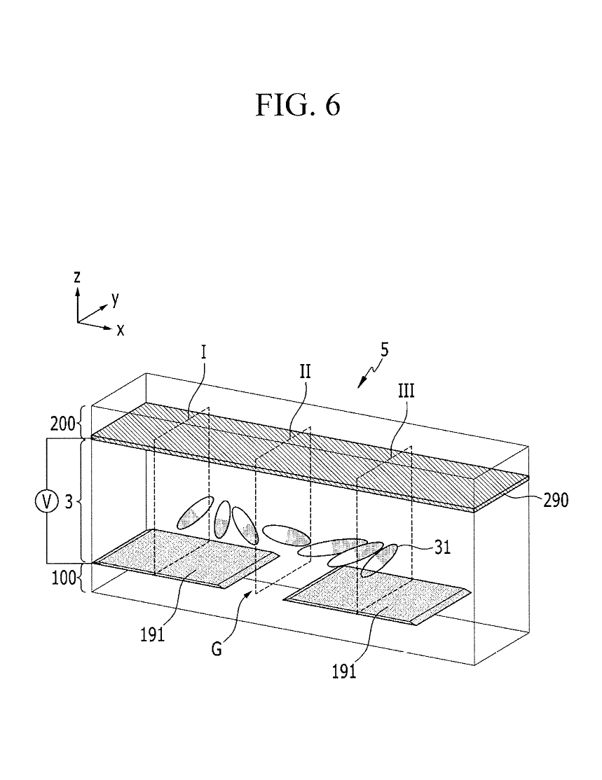

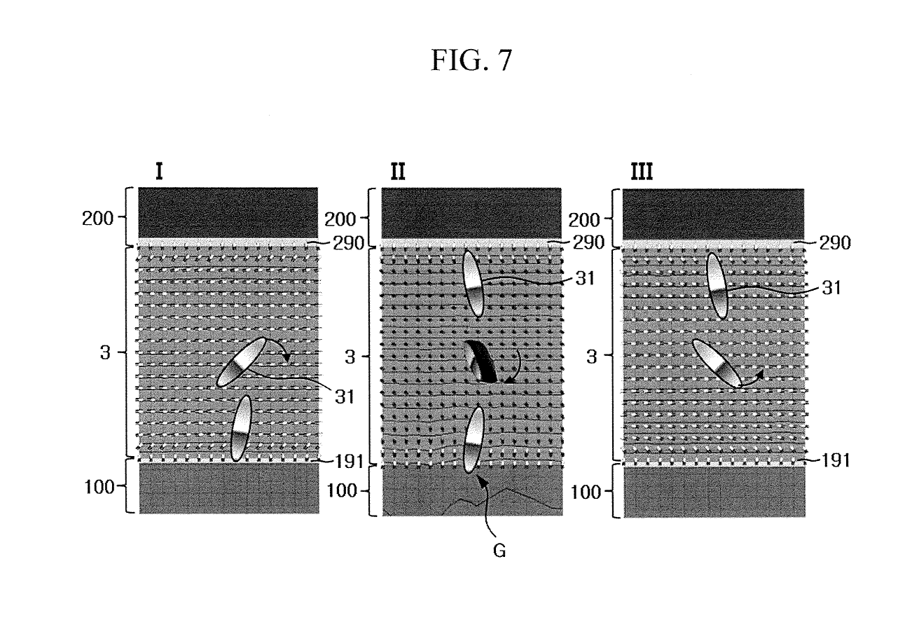

FIG. 4 is a perspective view of an arrangement of liquid crystal molecules when no voltage difference is applied to a first plate and a second plate of an optical modulation device according to an exemplary embodiment of the present disclosure, FIG. 5 is a cross-sectional view of the optical modulation device shown in FIG. 4 taken along planes I, II, and III, FIG. 6 is a perspective view of an arrangement of liquid crystal molecules when a voltage difference is applied to a first plate and a second plate of an optical modulation device according to an exemplary embodiment of the present disclosure, and FIG. 7 is a cross-sectional view of the optical modulation device shown in FIG. 6 taken along planes I, II, and III.

Referring to FIG. 4 and FIG. 5, when no voltage difference is applied between the lower electrode 191 of the first plate 100 and the upper electrode 290 of the second plate 200, so that no electric field is generated in the liquid crystal layer 3, the liquid crystal molecules 31 are aligned with an initial pretilt angle. FIG. 5 shows a cross-sectional view taken along plane I corresponding to one lower electrode 191 of the optical modulation device 5 shown in FIG. 4, a cross-sectional view taken along the plane II corresponding to the space G between two adjacent lower electrodes 191, and a cross-sectional view taken along the plane III corresponding to the lower electrode 191 adjacent to the other lower electrode 191. Referring to these cross sections, it may be seen that the alignment of the liquid crystal molecules 31 may be constant throughout the liquid crystal layer. In the drawings, some liquid crystal molecules 31 may appear to penetrate the region of the first plate 100 or the second plate 200, however this is for convenience of explanation, and in reality, no liquid crystal molecules 31 penetrate the region of the first plate 100 or the second plate 200.

The liquid crystal molecules 31 near the first plate 100 and the second plate 200 are initially aligned parallel to the alignment directions of the aligners 11 and 21, so that the pretilt direction of the liquid crystal molecules 31 near the first plate 100 and the pretilt direction of the liquid crystal molecules 31 near the second plate 200 are opposite rather than parallel to each other. That is, the liquid crystal molecules 31 near the first plate 100 and the liquid crystal molecules 31 near the second plate 200 may be inclined symmetrically with each other with reference to a transverse center line extending along a center of the liquid crystal layer 3. For example, if the liquid crystal molecules 31 near the first plate 100 are inclined rightward, the liquid crystal molecules 31 near the second plate 200 may be inclined leftward.

Referring to FIG. 6 and FIG. 7, a voltage difference greater than a threshold voltage is applied between the lower electrode 191 of the first plate 100 and the upper electrode 290 of the second plate 200 so that the liquid crystal molecules 31 incline in a direction perpendicular to the direction of the electric field generated in the liquid crystal layer 3. Accordingly, as shown in FIG. 6 and FIG. 7, the liquid crystal molecules 31 are inclined substantially parallel to the surface of the first plate 100 or the second plate 200 to have an in-plane arrangement, and the long axes of the liquid crystal molecules 31 rotate in-plane. The in-plane arrangement means that the long axes of the liquid crystal molecules 31 are aligned parallel to the surface of the first plate 100 or the second plate 200.

In this case, the rotation angle on the in-plane of the liquid crystal molecules 31, that is, the azimuthal angle, may change depending on the voltage applied to the lower electrode 191 and the upper electrode 290, and may result in a spiral depending on the position in the x-axis direction.

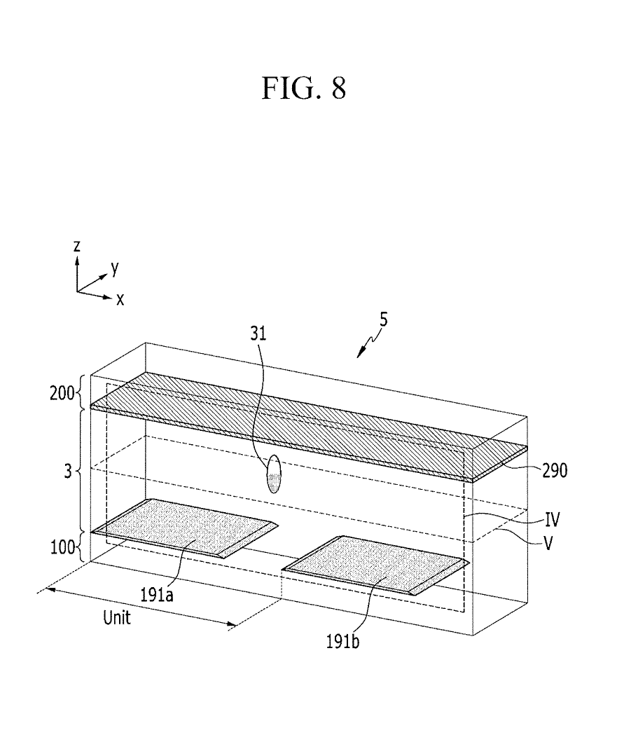

Next, a driving method and an operation of the optical modulation device 5 according to an exemplary embodiment of the present disclosure will be described with reference to FIG. 8 to FIG. 13, along with the previously-described drawings.

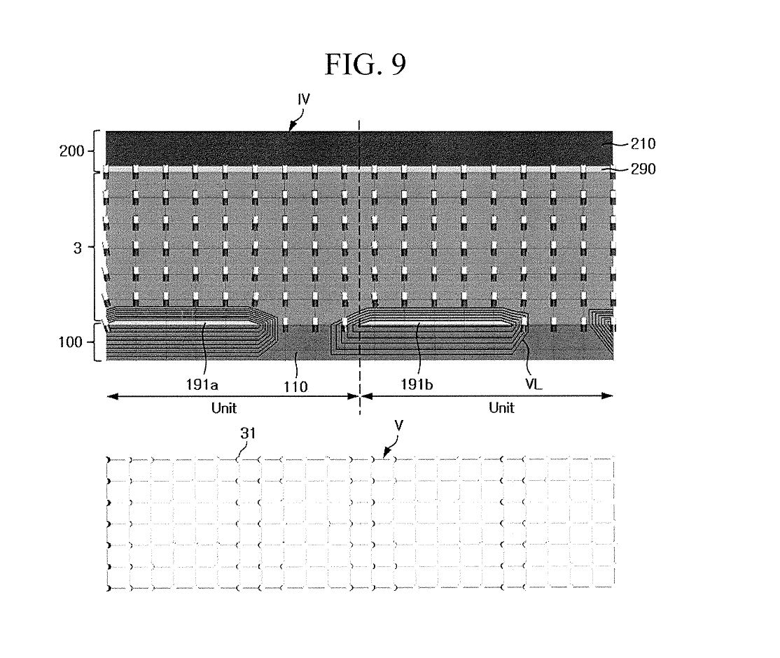

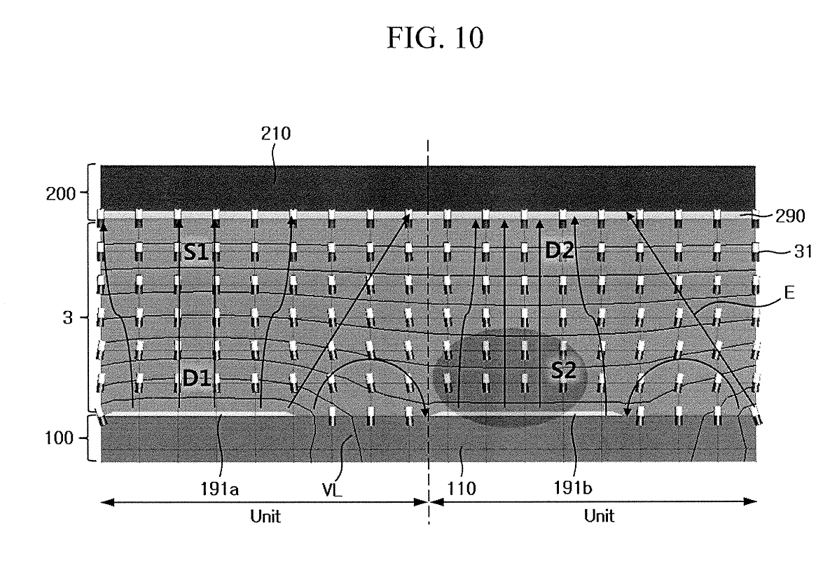

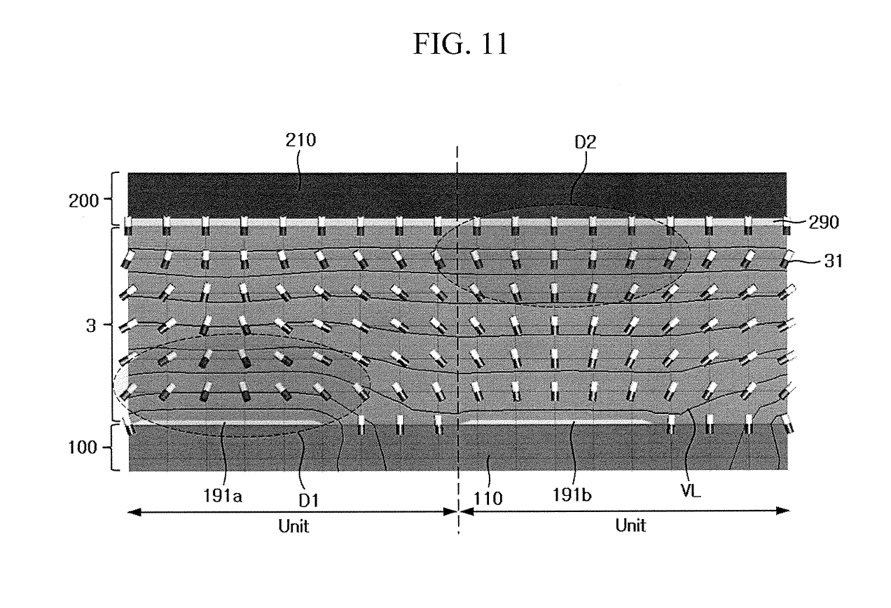

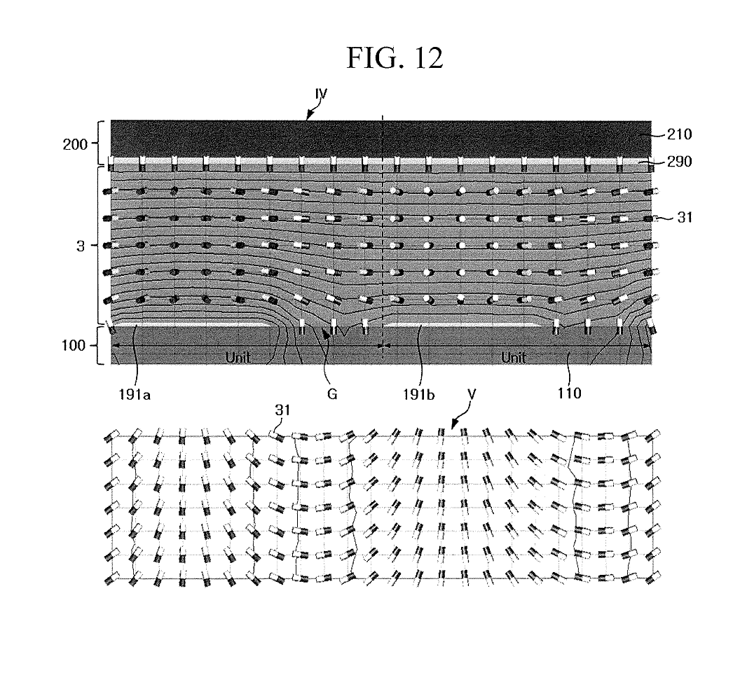

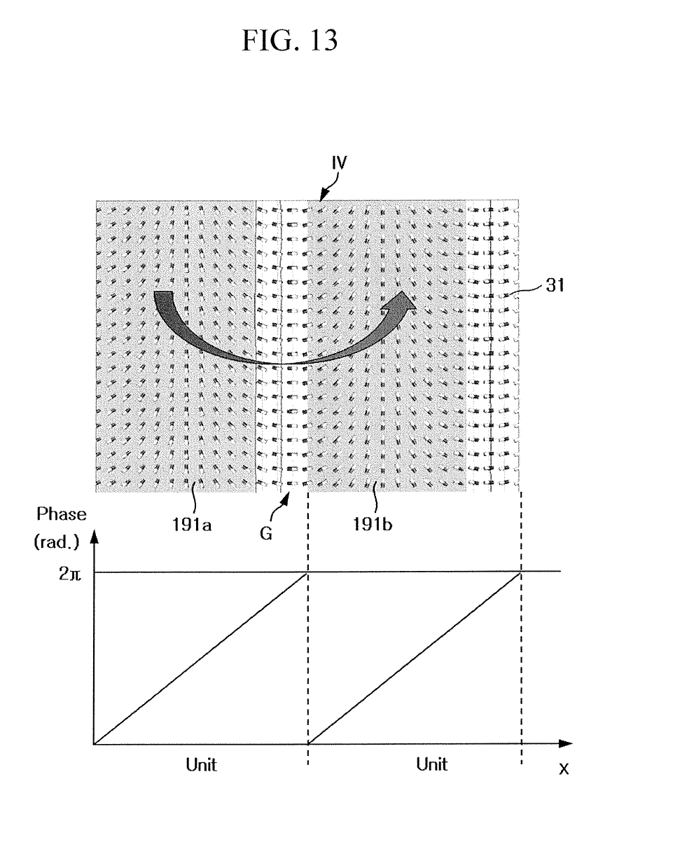

FIG. 8 is a perspective view of an optical modulation device according to an exemplary embodiment of the present disclosure, FIG. 9 shows two cross-sectional views of an arrangement of liquid crystal molecules before applying a voltage difference to a first plate and a second plate of an optical modulation device according to an exemplary embodiment of the present disclosure, taken along planes IV and V of FIG. 8, FIG. 10 is a cross-sectional view of an arrangement of liquid crystal molecules directly after applying a driving signal to an optical modulation device according to an exemplary embodiment of the present disclosure, taken along a plane IV of FIG. 8, FIG. 11 is a cross-sectional view of an arrangement of liquid crystal molecules before stabilizing after a driving signal was applied to an optical modulation device according to an exemplary embodiment of the present disclosure, taken along a plane IV of FIG. 8, FIG. 12 shows two cross-sectional views of an arrangement of liquid crystal molecules that are stable after a driving signal was applied to an optical modulation device according to an exemplary embodiment of the present disclosure, taken along planes IV and V of FIG. 8, and FIG. 13 is a cross-sectional view of an arrangement of liquid crystal molecules that are stable after a driving signal was applied to an optical modulation device according to an exemplary embodiment of the present disclosure, taken along a plane V of FIG. 8, and a graph showing a phase change corresponding thereto.

FIG. 8 shows the optical modulation device 5 with a liquid crystal layer according to an exemplary embodiment of the present disclosure, which has the same structure as a previously-described exemplary embodiment. The optical modulation device 5 may include a plurality of unit regions, and each unit region Unit may include at least one lower electrode 191. In a present exemplary embodiment, each unit region includes one lower electrode 191, and two lower electrodes 191a and 191b positioned in two adjacent unit regions will now be described. The two lower electrodes 191a and 191b are referred to as a first electrode 191a and a second electrode 191b.

FIG. 9 shows two cross-sectional views of the arrangement of the liquid crystal molecules 31 before a voltage difference is applied between the first and second electrodes 191a and 191b of the first plate 100 and the upper electrode 290 of the second plate 200, taken along the planes IV and V of FIG. 8. The liquid crystal molecules 31 are initially aligned in a direction substantially perpendicular to the surface of the first plate 100 and the second plate 200, and may be pretilted along the alignment directions R1 and R2 of the first plate 100 and the second plate 200. Equipotential lines VL in the liquid crystal layer 3 are shown. In this case, substantially the same voltage, for a voltage difference of 0 V, may be applied to the first and second electrodes 191a and 191b and the upper electrode 290, and in this case, the optical modulation device 5 may be in a turn-off state.

FIG. 10 is a cross-sectional view of the arrangement of the liquid crystal molecules 31 directly after an initial voltage difference is applied between the first and second electrodes 191a and 191b and the upper electrode 290 taken along the plane IV of FIG. 8. The electric field E is generated in the liquid crystal layer 3, and the equipotential lines VL are shown. In this case, since the first and second electrodes 191a and 191b have an edge side, as shown in FIG. 12, a fringe field may be formed between the edge side of the first and second electrodes 191a and 191b and the upper electrode 290.

The voltages of the driving signal applied to the first and second electrodes 191a and 191b and the upper electrode 290 may be determined to create an electric field E intensity distribution shown in FIG. 10.

Directly after the driving signal is applied, in the liquid crystal layer 3 of the unit region (Unit) that includes the first electrode 191a, the intensity of the electric field in a region D1 near the first plate 100 is greater than the intensity of the electric field in a region S1 near the second plate 200, and in the liquid crystal layer 3 of the unit region (Unit) that includes the second electrode 191b, the intensity of the electric field in a region S2 near the first plate 100 is less than the electric field in a region D2 near the second plate 200.

The voltages applied to the first electrode 191aand the second electrode 191b of two adjacent unit regions are different (Unit), and the intensity of the electric field in the region S2 near the second electrode 191b may be less than the intensity of the electric field in the region D1 near the first electrode 191a.

For this, when the voltage applied to the first and second electrodes 191a and 191b is positive with reference to the voltage of the upper electrode 290, the voltage applied to the first electrode 191a may be greater than the voltage applied to the second electrode 191b. In contrast, when the voltage applied to the first and second electrodes 191a and 191b is negative with reference to the voltage of the upper electrode 290, the voltage applied to the first electrode 191a may be less than the voltage applied to the second electrode 191b. The upper electrode 290 may be applied with a voltage that differs from the voltages applied to the first and second electrodes 191a and 191b, and in particular, the upper electrode 290 may be applied with a voltage that is less than the voltages applied to the first and second electrodes 191a and 191b.

FIG. 11 is a cross-sectional view of the arrangement of the liquid crystal molecules 31 that react to the electric field E generated in the liquid crystal layer 3 after the driving signal is applied to the optical modulation device 5, taken along the plane IV of FIG. 8. As described above, in the liquid crystal layer 3 corresponding to the first electrode 191a, the electric field in the region D1 near the first electrode 191a is greatest, so that the inclined direction of the liquid crystal molecules 31 of region D1 determine the in-plane arrangement direction of the liquid crystal molecules 31 that correspond to the first electrode 191a. Accordingly, in a region corresponding to the first electrode 191a, the liquid crystal molecules 31 are inclined at the initial pretilt direction of the liquid crystal molecules 31 near the first plate 100, thereby forming an in-plane arrangement.

In contrast, in the liquid crystal layer 3 corresponding to the second electrode 191b, the electric field in the region D2 near the upper electrode 290 is greatest, so that the inclined direction of the liquid crystal molecules 31 of region D2 determine the in-plane arrangement direction of the liquid crystal molecules 31. Accordingly, in a region corresponding to the second electrode 191b, the liquid crystal molecules 31 are increased at the initial pretilt direction near the second plate 200, thereby forming an in-plane arrangement. The initial pretilt direction of the liquid crystal molecules 31 near the first plate 100 are opposite to the initial pretilt direction of the liquid crystal molecules 31 near the second plate 200 such that the inclined direction of the liquid crystal molecules 31 corresponding to the first electrode 191a are opposite to the inclined direction of the liquid crystal molecules 31 corresponding to the second electrode 191b.

FIG. 12 shows two cross-sectional views of the arrangement of stable liquid crystal molecules 31 after the driving signal was applied to the optical modulation device 5 shown in FIG. 8, taken along the planes IV and V of FIG. 8. The in-plane arrangement direction of the liquid crystal molecules 31 corresponding to the first electrode 191a is opposite to the in-plane arrangement direction of the liquid crystal molecules 31 corresponding to the second electrode 191b, and the liquid crystal molecules 31 corresponding to the space G between the adjacent first and second electrodes 191a and 191b continuously rotate along the x-axis direction, thereby forming the spiral arrangement.

Referring to FIG. 12 and FIG. 13, the spiral arrangement of the liquid crystal molecules 31 may form a “U” arrangement. The region where the liquid crystal molecules 31 have rotated along the x-axis direction by 180 degrees is defined as one unit region (Unit). In a present exemplary embodiment, one unit region (Unit) may include the space G between the first electrode 191a and the second electrode 191b adjacent thereto.

Finally, the liquid crystal layer 3 of the optical modulation device 5 may retard the phase that change along the x-axis direction for the incident light. A state of the optical modulation device 5 when phase retardation changes along the x-axis direction due to the application of a driving signal to the first and second electrodes 191a and 191b and the upper electrode 290 is a turn-on state.

As described above, the optical modulation device 5 that satisfies Equation 1 may be a half-wave plate which can reverse the rotation direction of incident and circularly-polarized light. FIG. 13 shows the phase change as a function of position in the x-axis direction when right-circularly polarized light is incident on the optical modulation device 5. Right-circularly polarized light passing through the optical modulation device 5 changes into left-circularly polarized light, and the phase retardation value of the liquid crystal layer 3 differs depending on the x-axis direction so that the phase of the emitted circularly-polarized light continuously changes along a spatial direction.

In general, if the optical axis of a half-wave plate rotates by φ on the in-plane, since the phase of the output light changes by 2φ, as shown in FIG. 13, the phase of light emitted in one unit region (Unit), where the azimuth angle of the long axis of the liquid crystal molecules 31 changes by 180 degrees, changes along the x-axis direction from 0 to 2π (radian). This is referred to as a foreword phase inclination. This phase change may be repeated every unit region (Unit), and a phase inclination portion of the lens may be realized when light that is circularly-polarized in a predetermined direction propagates to the optical modulation device 5 to form the foreword phase inclination.

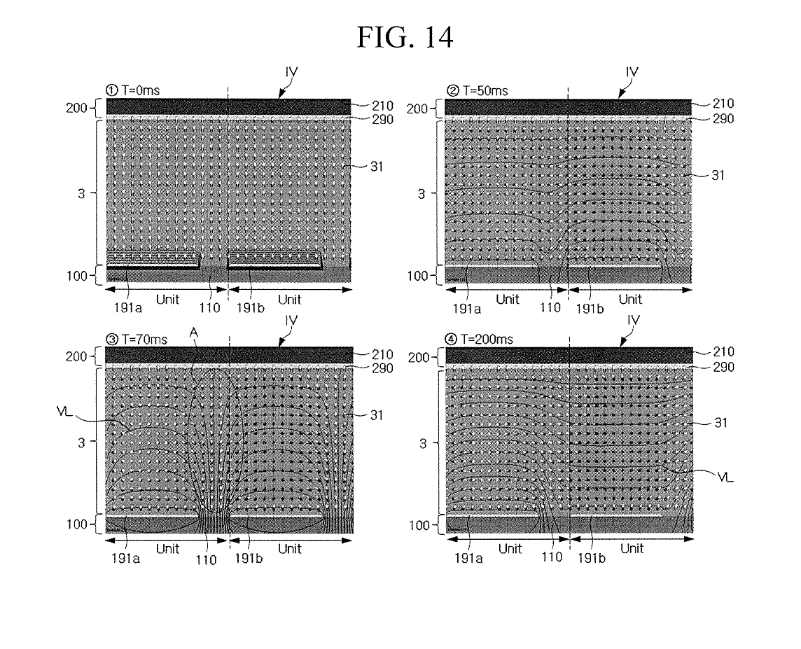

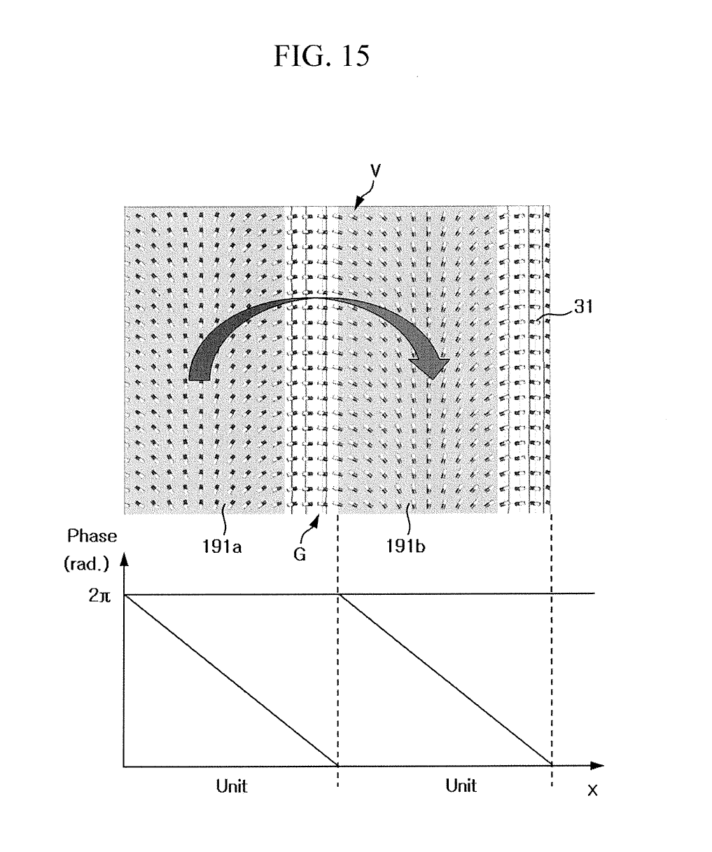

Now, a method of realizing a reverse phase inclination using the optical modulation device 5 according to an exemplary embodiment of the present disclosure will be described with reference to FIG. 14 and FIG. 15 along with the above-described drawings.

FIG. 14 is a cross-sectional view of an arrangement of liquid crystal molecules before applying a voltage difference to a first plate and a second plate of an optical modulation device according to an exemplary embodiment of the present disclosure and after a driving signal was applied in three steps, taken along a plane IV of FIG. 8, and FIG. 15 is a cross-sectional view of an arrangement of liquid crystal molecules that are stable after sequentially applying a driving signal in three steps to an optical modulation device according to an exemplary embodiment of the present disclosure, taken along a plane V of FIG. 8.

Referring to an upper-left drawing of FIG. 14, the liquid crystal molecules 31, when no voltages are applied to the first and second electrodes 191a and 191b and the upper electrode 290, are initially aligned in a direction substantially perpendicular to the plane surface of the first plate 100 and second plate 200, and may be pretilted along the alignment direction of the first plate 100 and the second plate 200 as described above.

Referring to an upper-right drawing of FIG. 14, an example in which the voltage applied to the first electrode 191a is less than the voltage applied to the second electrode 191b will be described, which differs from the exemplary embodiments shown in FIG. 10 to FIG. 13. However, the same signal as the driving signal for the above-described “u” arrangement may be applied. This may be referred to as a step 1 driving signal. For example, the first electrode 191a may be applied with about 5 V and the second electrode 191b may be applied with about 6 V.

After the step 1 driving signal is applied to the first and second electrodes 191a and 191b, a step 2 driving signal may be applied to the lower electrodes 191a and 191b and the upper electrode 290 after a predetermined time. A step 2 driving signal applies to adjacent first and second electrodes 191a and 191b voltages of opposite polarities with respect to the voltage applied to the upper electrode 290. For example, the first electrode 191a may be applied with a voltage of about −6 V with respect to the voltage of the upper electrode 290 and the second electrode 191b may be applied with a voltage of about 6 V, and this may be reversed.

Thus, equipotential lines VL as shown in a left-lower drawing of FIG. 14 are formed and the liquid crystal molecules 31 of region A corresponding to the space G between the first and second electrodes 191a and 191b are aligned in a direction approximately perpendicular to the substrates 100 and 200, which breaks the in-plane spiral arrangement.

Next, after applying a step 2 driving signal to the optical modulation device 5, a step 3 driving signal is applied to the lower electrodes 191a and 191b and the upper electrode 290 after a predetermined time, and the step 3 driving signal may be maintained during the rest of the period of the corresponding frame.

A step 3 driving signal has a voltage level similar to the step 1 driving signal, except that the relative magnitudes of the voltages applied to the first electrode 191a and the second electrode 191b may be reversed. That is, if the step 1 driving signal applies a voltage to the first electrode 191a that is less than the voltage applied to the second electrode 191b, the step 3 driving signal applies a voltage to the first electrode 191a that may be greater than the voltage applied to the second electrode 191b. For example, the first electrode 191a may be applied with a voltage of about 10 V, the second electrode 191b may be applied with a voltage of about 6 V, and the upper electrode 290 may be applied with a voltage of about 0 V.

Thus, as shown in the right-lower drawing of FIG. 14, the liquid crystal molecules 31 are rearranged based on the electric field generated in the liquid crystal layer 3. In detail, the liquid crystal molecules 31 are inclined to be substantially parallel to the surface of the first plate 100 or the second plate 200 to form an in-plane arrangement, and the long axis rotates on the in-plane to form a spiral arrangement, as shown in FIG. 15, to form an “n” shape arrangement. The liquid crystal molecules 31 are arranged so that the azimuth angle of the long axes of the liquid crystal molecules 31 may change from about 180 degrees to about 0 degree over a period of a pitch of the lower electrode 191. The portion in which the azimuth angle of the long axes of the liquid crystal molecules 31 changes from about 180 degrees to about 0 degree may form one “n” shape in the arrangement.

As described above, the optical modulation device 5 that satisfies Equation 1 may be half-wave plate which can reverse the rotation direction of incident and circularly-polarized light. FIG. 15 shows the phase change as a function of position in the x-axis direction when right-circularly polarized light is incident on the optical modulation device 5. Right-circularly polarized light passing through the optical modulation device 5 changes into left-circularly polarized light, and the phase retardation value of the liquid crystal layer 3 differs depending on the x-axis direction so that the phase of the emitted circularly-polarized light continuously changes along a spatial direction.

In general, if the optical axis of a half-wave plate rotates by φ on the in-plane, since the phase of the output light changes by 2φ, as shown in FIG. 15, the phase of light emitted in one unit region (Unit) where the azimuth angle of the long axis of the liquid crystal molecules 31 is changed by 180 degrees is changed along the x-axis direction from 2π (radian) to 0. This is referred to as a reverse phase inclination. This phase change may be repeated every unit region (Unit), and a reverse phase inclination portion of the lens may be realized by using the optical modulation device 5.

As described above, according to an exemplary embodiment of the present disclosure, by controlling the in-plane rotation angle of the liquid crystal molecules 31 based on the application method of a driving signal, light phase may be variously modulated and the various light diffraction angles may be formed.

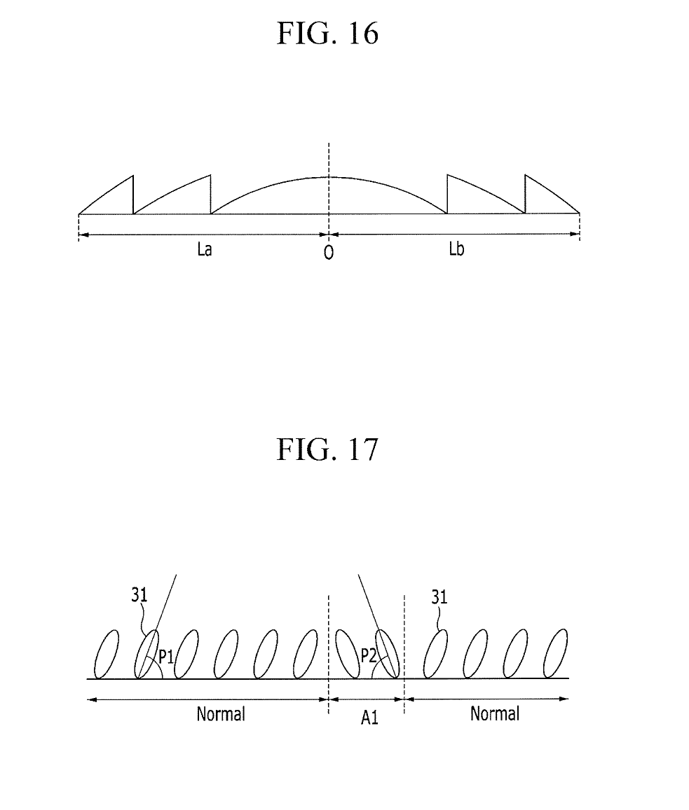

FIG. 16 shows a phase change as a function of a position of a lens realized using an optical modulation device according to an exemplary embodiment of the present disclosure. The optical modulation device 5 according to an exemplary embodiment of a present disclosure can realize both a foreword phase inclination and a reverse phase inclination by differentiating the application method of the driving signal based on the position as described above, to form an optical device such as a lens. As an example of a lens that can be realized by the optical modulation device 5, FIG. 16 shows the phase change as a function of position in a Fresnel lens. A Fresnel lens is a lens having optical characteristic of a Fresnel zone plate, and may have an effective phase delay which is identical or similar to that of a solid convex lens or a GRIN lens since the refractive index distribution periodically repeats.

As shown in FIG. 16, a Fresnel lens may have a left portion La with respect to a lens center O that includes a plurality of foreword phase inclination regions that may have different widths in the x-axis direction, and a right portion with respect to the lens center O that includes a plurality of reverse phase inclination regions that may have different widths in the x-axis direction. Accordingly, a portion of the optical modulation device 5 corresponding to the left portion La of the Fresnel lens may be used with the step 1 driving signal as described above to form the foreword phase inclination, and a portion of the optical modulation device 5 corresponding to the right portion Lb of the Fresnel lens may be used to form the reverse phase inclination, according to an above-described method. A method of forming a reverse phase inclination is not limited to that described above, and may be realized through different driving methods or through the addition or deformation of different structures.

The plurality of foreword phase inclinations included in the left portion La of a Fresnel lens may have different widths depending on position, and for this, the width of the lower electrode 191 corresponding to each foreword phase inclination and/or a number of the lower electrodes 191 included in one unit region (Unit) may be appropriately controlled. Likewise, the plurality of reverse phase inclinations included in the right portion Lb of a Fresnel lens may have different widths depending on position, and for this, the width of the lower electrodes 191 corresponding to each foreword phase inclination and/or a number of the lower electrodes 191 included in one unit region (Unit) may be appropriately controlled.

The phase curvature of the Fresnel lens may also be adjusted by controlling the voltage applied to the lower electrodes 191 and the upper electrode 290.

Next, an optical modulation device according to an exemplary embodiment of the present disclosure that may prevent the spread of a texture by liquid crystal molecules whose arrangement has been scattered by a foreign particle will be described with reference to FIG. 17 to FIG. 26 along with the above-described drawings.

FIG. 17 is a schematic cross-sectional view of the pretilt direction of liquid crystal molecules of a optical modulation device according to an exemplary embodiment of the present disclosure and an inclination direction of a scattered arrangement of liquid crystal molecules.

An optical modulation device according to an exemplary embodiment of the present disclosure may be substantially the same as the optical modulation device 5 according to an above-described exemplary embodiment so that a duplicate description is omitted.

Referring to FIG. 17, the liquid crystal molecules 31 of an optical modulation device according to an exemplary embodiment of the present disclosure may be aligned perpendicular to the first and second plates 200 as described above, and may be pre-tilted in predetermined directions. The pretilt angle P1 of the long axes of the liquid crystal molecules 31 at the surface of the first plate 100 or the second plate 200 may be substantially constant over the entire surface. As described above, the liquid crystal molecules 31 may have the predetermined pretilt angle P1 so that the liquid crystal molecules 31 may have a normal arrangement when the driving signal is applied. As described, a region where the liquid crystal molecules 31 of the optical modulation device form a normal arrangement is referred to as a normal region (Normal).

However, the initial pretilt arrangement of the liquid crystal molecules 31 may be scattered in a portion of the optical modulation device by an influence of several conditions that may be generated in the manufacturing process, for example, a foreign particle. This portion may be referred to as an abnormal region A1. In the abnormal region A1, the liquid crystal molecules 31 may have an abnormal inclination angle P2 at the surface of the first plate 100 or the second plate 200 that differs from the pretilt angle P1, and may be inclined in an opposite direction to the pretilt angle P1. If the abnormal region A1 spreads when the optical modulation device is driven, the portion where the liquid crystal molecules 31 are abnormally arranged increases in size, which breaks the spiral arrangement of the liquid crystal molecules 31 so that light passing through the optical modulation device is abnormally diffracted, which may cause the image projected through the optical modulation device to appear abnormal.

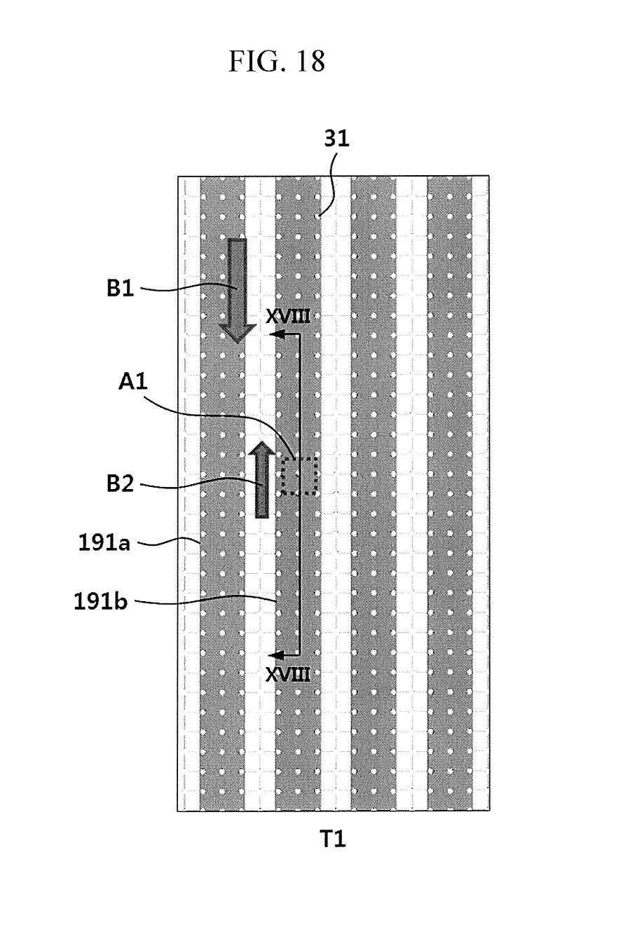

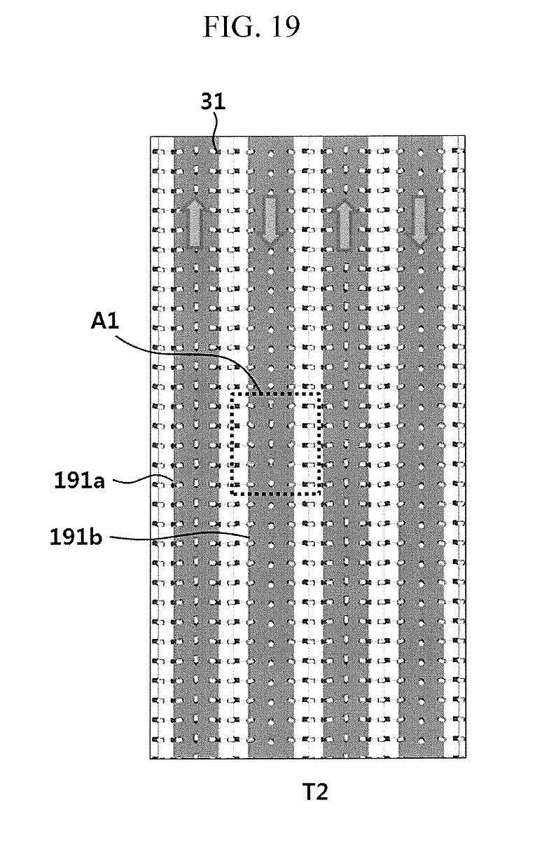

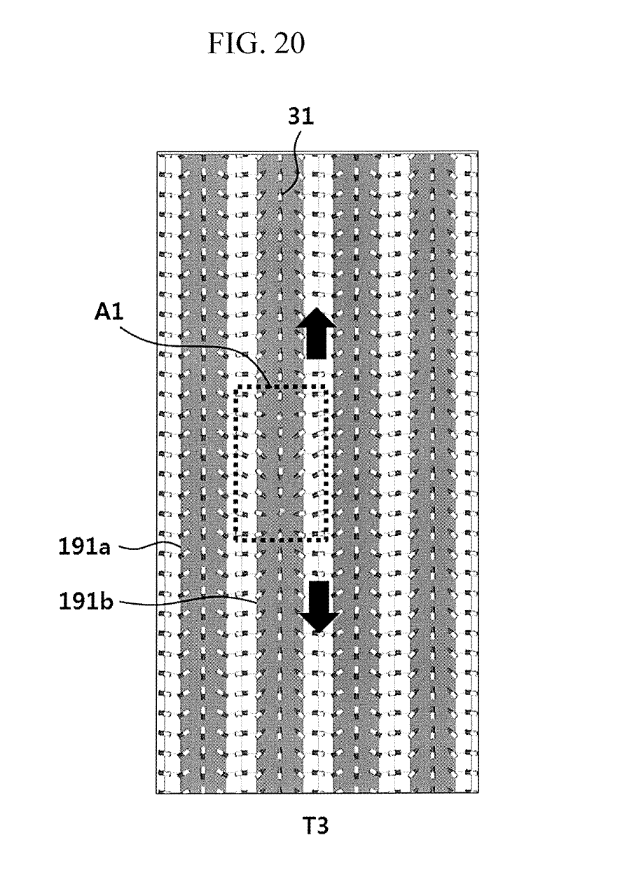

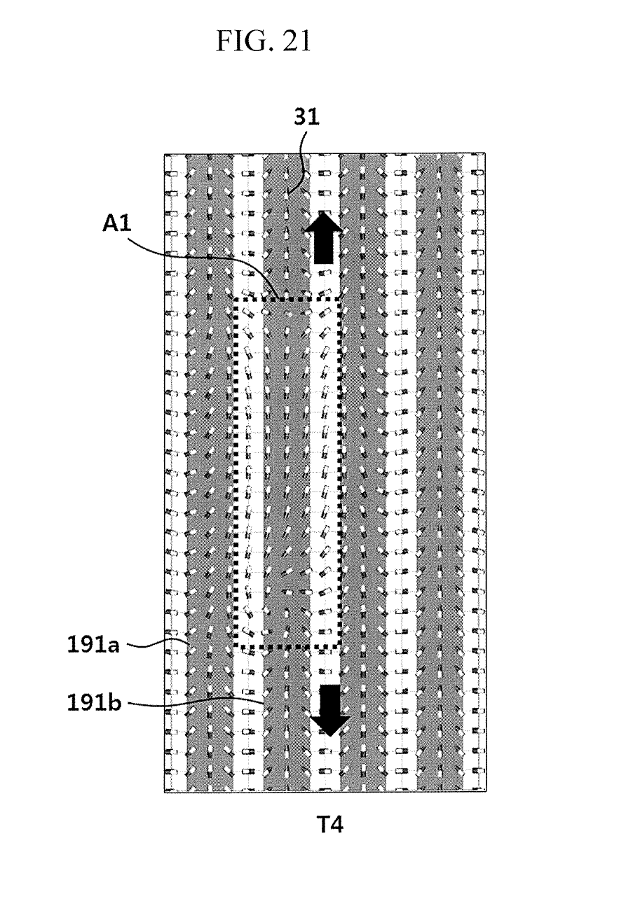

This situation will be described with reference to FIG. 18 to FIG. 21. FIG. 18 is a top plan view of a liquid crystal arrangement before a driving signal is applied to an optical modulation device according to an exemplary embodiment of the present disclosure, FIG. 19 is a top plan view of a liquid crystal arrangement after a driving signal was applied to an optical modulation device according to an exemplary embodiment of the present disclosure, FIG. 20 is a plane view of a region where an arrangement of liquid crystal molecules is scattered by a foreign particle after a driving signal was applied to an optical modulation device according to an exemplary embodiment of the present disclosure that shows how a state evolved from a state of an optical modulation device shown in FIG. 19, and FIG. 21 is a plane view of a region where an arrangement of liquid crystal molecules is scattered by a foreign particle after a driving signal was applied to an optical modulation device according to an exemplary embodiment of the present disclosure that shows how a state evolved from a state of an optical modulation device shown in FIG. 20.

First, referring to FIG. 18, before a driving signal is applied to the lower electrodes 191a and 191b at a first time T1, the liquid crystal molecules 31 are aligned substantially perpendicular to the first plate 100 and the second plate 200, and the liquid crystal molecules 31 near the first plate 100 are pretilted in the first direction B1. Also, the optical modulation device 5 may have an abnormal region A1 where the liquid crystal molecules 31 are aligned in the second direction B2 opposite to the first direction B1 by a foreign particle. The cross-sectional view taken along the plane XVIII-XVIII shown in FIG. 18 may be the same as in FIG. 17.

Next, referring to FIG. 19, if a driving signal is applied to the lower electrodes 191a and 191b at a second time T2 after the first time T1, as described above, the liquid crystal molecules 31 start to be inclined along an arrow direction shown in FIG. 19. Also, as time passes, the abnormal region A1 may gradually increase. The liquid crystal molecules 31 positioned in the abnormal region A1 were not aligned at the normal pretilt angle P1, so that the inclination direction thereof differs from the rest of the normal region.

Next, referring to FIG. 20, the liquid crystal molecules 31 form a ‘u’ shape arrangement or an ‘n’ shape arrangement as described above at a third time T3 after the second time T2, thereby forming a phase inclination. However, in the abnormal region A1, the inclination direction of the liquid crystal molecules 31 differs from the normal region so that the ‘u’ shape arrangement or the ‘n’ shape arrangement is not normally formed. Also, the liquid crystal molecules 31 of the abnormal region A1 affect the surrounding liquid crystal molecules 31 so that the abnormal region A1 may expand as shown by the arrows.

Next, referring to FIG. 21, it may be experimentally confirmed that as time passes the abnormal region A1 further expands as indicated by the arrows at a fourth time after the third time T3. In this way, if the abnormal region A1 continuously expands, it spreads to the entire optical modulation device and the optical modulation device may function abnormally.

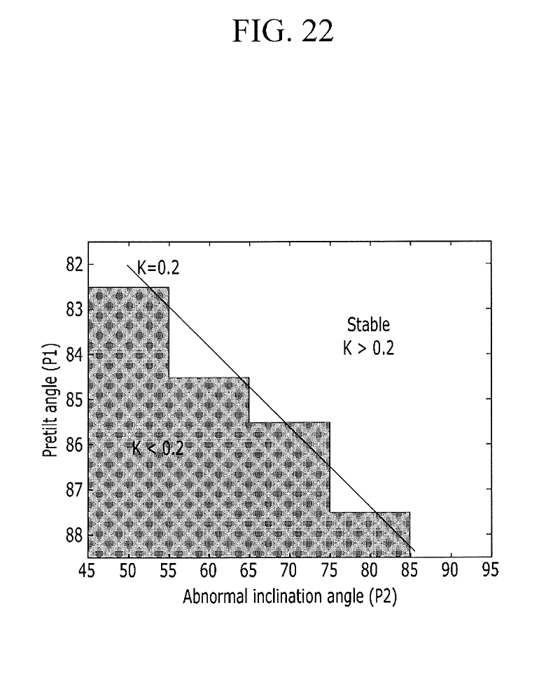

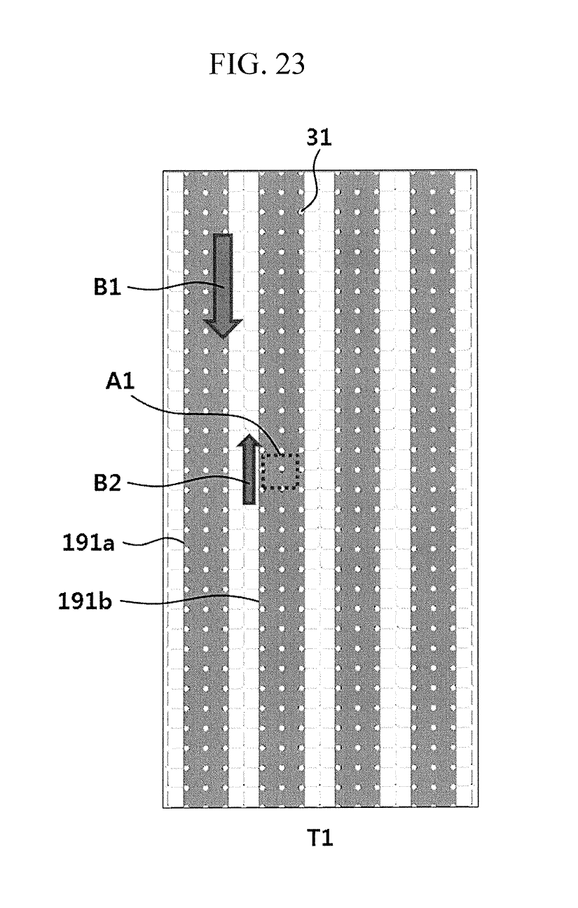

As described above, when an abnormal region A1, where the spiral arrangement of the liquid crystal molecules 31 is broken by the foreign particle, is present at any position, whether the expansion of the abnormal region A1 changes based on the initial pretilt angle P1 can be determined through routine tests. This will be described with reference to FIG. 22.

FIG. 22 is a graph of a relationship of a pretilt angle P1 of a liquid crystal molecule in a normal region of an optical modulation device according to an exemplary embodiment of the present disclosure to an abnormal inclination angle P2 of a liquid crystal molecule in the abnormal region A1 whose arrangement is scattered by a foreign particle.

Referring to FIG. 22, there is a linear relationship between the initial pretilt angle P1 of the liquid crystal molecule 31 and the abnormal inclination angle P2 of the liquid crystal molecule 31 of the abnormal region A1. This may be represented by Equation 2.

(90-P1)/ (90-P2)=K. Equation 2:

In Equation 2, the unit of the pretilt angle P1 and the abnormal inclination angle P2 is a degree(°). Referring to FIG. 22 and Equation 2, K is a stabilization constant, and when the stabilization constant K is greater than about 0.2, although the abnormal region A1 is initially present in the liquid crystal layer 3, the abnormal region A1 does not expand and gradually disappears, thereby being stable. However, when the stabilization constant K is less than about 0.2, if the abnormal region A1 is initially present in the liquid crystal layer 3, as shown in FIG. 18 to FIG. 21, it may be confirmed that the abnormal region A1 gradually increases with the operation of the optical modulation device 5 so that the portion having a broken spiral arrangement of the liquid crystal molecule 31 diffuses.

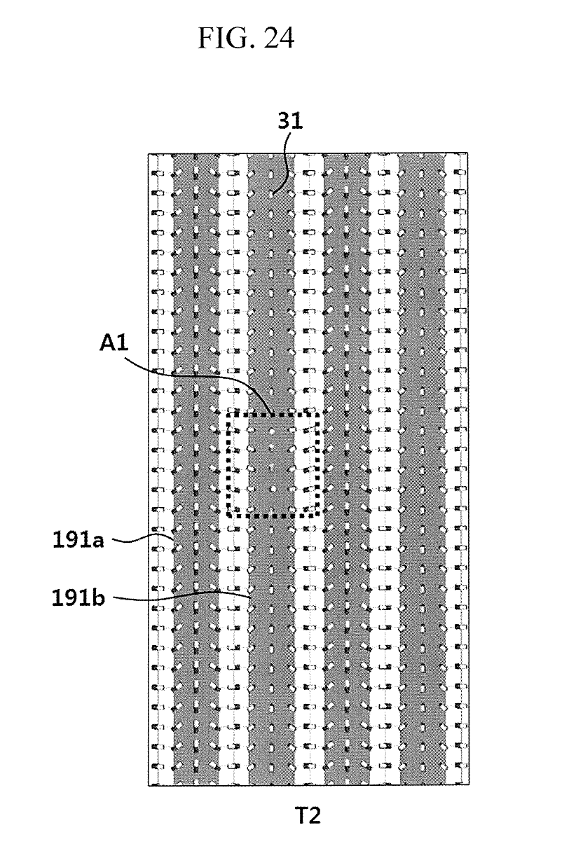

That is, if the liquid crystal molecule 31 has an initial pretilt angle P1 when the stabilization constant K of Equation 2 is greater than about 0.2, although there is an abnormal region A1 generated by the foreign particle, the spiral arrangement of the liquid crystal molecule 31 may be maintained in the entire optical modulation device. The pretilt angle P1 may change due to the abnormal inclination angle P2 of the liquid crystal molecule 31 in the abnormal region A1. However, the ratio of the normal pretilt angle P1 and the abnormal inclination angle P2 is constant, as expressed in Equation 2. Thus, if an abnormal region is present in the optical modulation device, the value of the abnormal inclination angle P2 may be confirmed in the abnormal region A1, and then the alignment degree of the first plate 100 and the second plate 200 can be adjusted to control the pretilt angle P1 of the liquid crystal molecule 31. This optical modulation device according to an exemplary embodiment of the present disclosure will be described with reference to FIG. 23 to FIG. 26.

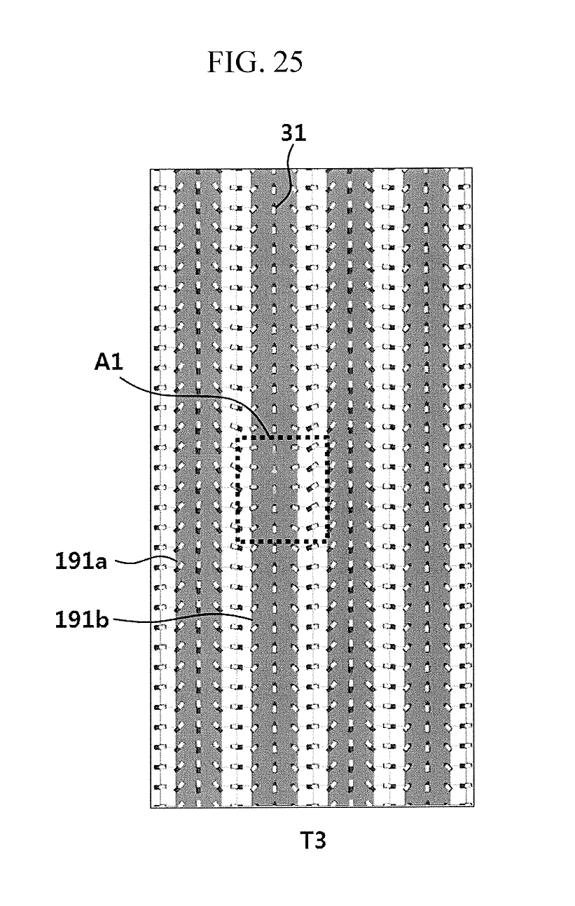

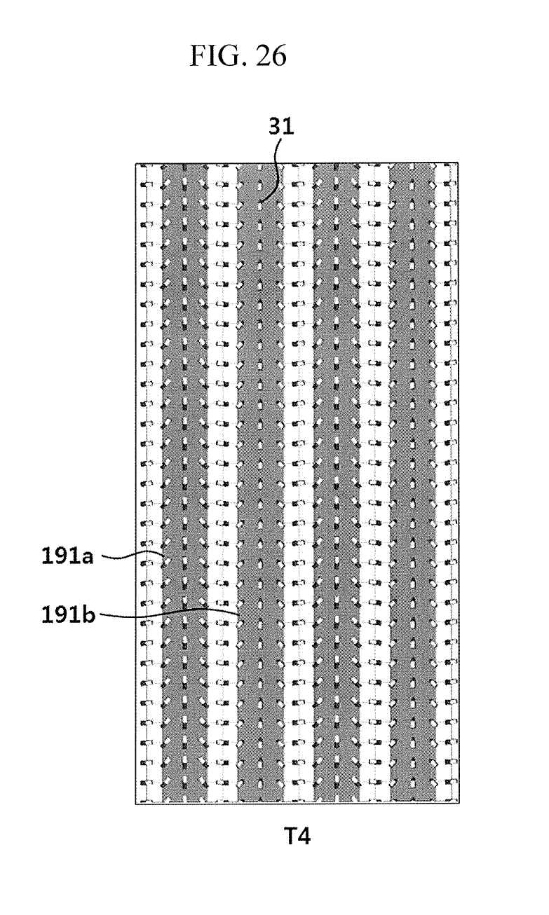

FIG. 23 is a top plan view of a liquid crystal arrangement before applying a driving signal to an optical modulation device according to an exemplary embodiment of the present disclosure, FIG. 24 is a top plan view of a liquid crystal arrangement after applying a driving signal to an optical modulation device according to an exemplary embodiment of the present disclosure, FIG. 25 is a plane view of a region where an arrangement of liquid crystal molecules is scattered by a foreign particle after a driving signal was applied to an optical modulation device according to an exemplary embodiment of the present disclosure that shows how a state has evolved from a state of an optical modulation device shown in FIG. 24, and FIG. 26 is a plane view of a region where a liquid crystal arrangement is scattered by a foreign particle after a driving signal was applied to an optical modulation device according to an exemplary embodiment of the present disclosure that shows how a state has evolved from a state of an optical modulation device shown in FIG. 25.

First, referring to FIG. 23, before a driving signal is applied to the lower electrodes 191a and 191b at a first time T1, the liquid crystal molecules 31 are aligned substantially perpendicular to the first plate 100 and the second plate 200, and the liquid crystal molecules 31 near the first plate 100 are pretilted in the first direction B1. Also, an abnormal region A1 generated by the foreign particle where the arrangement of the liquid crystal molecules 31 is inclined in the second direction B2 opposite to the first direction B1 may be present.

Next, referring to FIG. 24, when a driving signal is applied to the lower electrodes 191a and 191b at a second time T2 after the first time T1, as described above, the liquid crystal molecules 31 start to incline. As the abnormal region A1 gradually increases, a portion is generated where the inclination direction of the liquid crystal molecules 31 is scattered.

Next, referring to FIG. 25, the liquid crystal molecules 31 form a ‘u’ shape arrangement or an ‘n’ shape arrangement at a third time T3 after the second time T2 as described above, thereby forming a phase inclination. It may be confirmed that the abnormal region A1 has not further expanded, different from FIG. 20. This is because a control force for the abnormal region A1 of the liquid crystal molecules 31 is large when the stabilization constant K is set to be greater than about 0.2 in Equation 2.

Next, referring to FIG. 26, it may be confirmed that the abnormal region A1 has substantially disappeared at a fourth time T4 after the third time T3. Accordingly, the optical modulation device may be normally and stably operated so that a phase of the light propagating therethrough may be normally controlled.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. An optical modulation device comprising:
a first plate and a second plate that face each other and include a plurality of unit regions; and
a liquid crystal layer positioned between the first plate and the second plate and that includes a plurality of liquid crystal molecules,
wherein the first plate includes a plurality of lower electrodes, each first electrode corresponding to one of the plurality of unit regions,
the second plate includes at least one upper electrode,
a pretilt angle P1 of a long axis of the liquid crystal molecules with respect to a surface of the first plate or the second plate when no electric field is generated in the liquid crystal layer and an abnormal inclination angle P2 of the liquid crystal molecules with respect to a surface of the first plate or the second plate in an abnormal region of the liquid crystal layer satisfy (90-P1)/(90-P2)=K,
wherein K is larger than about 0.2.

2. The optical modulation device of claim 1, wherein
when no electric field is generated in the liquid crystal layer, the pretilt direction of the liquid crystal molecules near the first plate and the pretilt direction of the liquid crystal molecules near the second plate are opposite to each other.

3. The optical modulation device of claim 1, wherein
when an electric field is generated in the liquid crystal layer by the plurality of lower electrodes and the at least one upper electrode,
an electric field intensity in a region of the liquid crystal layer near a first lower electrode of the plurality of lower electrodes is greater than the electric field intensity in a region of the liquid crystal layer near the upper electrode.

4. The optical modulation device of claim 3, wherein
the electric field intensity in a region of the liquid crystal layer near a second lower electrode of the plurality of lower electrodes that is adjacent to the first lower electrode is less than the electric field intensity in a region of the liquid crystal layer near the upper electrode.

5. The optical modulation device of claim 5, wherein
a voltage applied to the first lower electrode is greater than a voltage applied to the second lower electrode.

6. The optical modulation device of claim 3, wherein
the abnormal region is generated by a foreign particle that is present in the liquid crystal layer.

7. The optical modulation device of claim 6, wherein
the abnormal region gradually disappears after the electric field is generated in the liquid crystal layer.

8. The optical modulation device of claim 1, wherein
the first plate includes a first aligner and the second plate includes a second aligner,
an alignment direction of the first aligner and an alignment direction of the second aligner are substantially parallel to each other, and
the pretilt direction of the liquid crystal molecules near the first plate is determined by the alignment direction of the first aligner and the pretilt direction of the liquid crystal molecules near the second plate is determined by the alignment direction of the second aligner.

9. An optical modulation device comprising:
a first plate that includes a plurality of lower electrodes spaced apart from each other, wherein each lower electrode is associated with one of a plurality of unit regions;
a second plate that faces the first plate and that includes at least one upper electrode; and
a liquid crystal layer positioned between the first plate and the second plate and that includes a plurality of liquid crystal molecules,
wherein when an electric field is generated in the liquid crystal layer by the plurality of lower electrodes and the at least one upper electrode,
an electric field intensity in a first unit region of the liquid crystal layer near a first lower electrode of the plurality of lower electrodes is greater than the electric field intensity in the first unit region near the upper electrode, and
the electric field intensity in a second unit region the liquid crystal layer near a second lower electrode of the plurality of lower electrodes that is adjacent to the first lower electrode is less than the electric field intensity in the second unit region near the upper electrode.

10. The optical modulation device of claim 9, wherein
a pretilt angle P1 of a long axis of the liquid crystal molecules with respect to a surface of the first plate or the second plate when no electric field is generated in the liquid crystal layer and an abnormal inclination angle P2 of the liquid crystal molecules with respect to a surface of the first plate or the second plate in an abnormal region of the liquid crystal layer satisfy (90-P1)/(90-P2)=K, wherein K is larger than about 0.2.

11. The optical modulation device of claim 9, wherein
a voltage applied to the first lower electrode is greater than a voltage applied to the second lower electrode

12. The optical modulation device of claim 9, wherein
the abnormal region is generated by a foreign particle that is present in the liquid crystal layer.

13. The optical modulation device of claim 12, wherein
the abnormal region gradually disappears after the electric field is generated in the liquid crystal layer.

14. The optical modulation device of claim 9, wherein
the first plate includes a first aligner and the second plate includes a second aligner,
an alignment direction of the first aligner and an alignment direction of the second aligner are substantially parallel to each other, and
the pretilt direction of the liquid crystal molecules near the first plate is determined by the alignment direction of the first aligner and the pretilt direction of the liquid crystal molecules near the second plate is determined by the alignment direction of the second aligner.

15. The optical modulation device of claim 14, wherein
when no electric field is generated in the liquid crystal layer, the pretilt direction of the liquid crystal molecules near the first plate and the pretilt direction of the liquid crystal molecules near the second plate are opposite to each other.

16. A method of driving an optical modulation device that includes a first plate that include a plurality of first and second lower electrodes that alternate with each other, a second plate that faces the first plate and that has at least one upper electrode, and a liquid crystal layer positioned between the first plate and the second plate and that includes a plurality of liquid crystal molecules, the method comprising the steps of:
applying a first voltage to the plurality of first and second lower electrodes and the at least one upper electrode to generate an electric field in the liquid crystal layer, wherein the voltage applied to a first lower electrode differs from a voltage applied to a second lower electrode;
applying second voltages of equal magnitudes and opposite polarities to each of the first and second lower electrodes, respectively; and
applying a third voltage to the plurality of first and second lower electrodes, wherein relative magnitudes of the voltages applied to the first lower electrodes and the second lower electrodes are reversed from those of the first voltage.

17. The method of claim 16, wherein
a pretilt angle P1 of a long axis of the liquid crystal molecules with respect to a surface of the first plate or the second plate when no electric field is generated in the liquid crystal layer and an abnormal inclination angle P2 of the liquid crystal molecules with respect to a surface of the first plate or the second plate in an abnormal region of the liquid crystal layer satisfy (90-P1)/(90-P2)=K, wherein K is larger than about 0.2.

18. The method of claim 17, wherein the abnormal region is generated by a foreign particle present in the liquid crystal layer, wherein the abnormal region gradually disappears after the electric field is generated in the liquid crystal layer.

19. The method of claim 17, wherein
when no electric field is generated in the liquid crystal layer, the pretilt direction of the liquid crystal molecules near the first plate and the pretilt direction of the liquid crystal molecules near the second plate are opposite to each other.
